(19) United States
(12) Patent Application Publication
(10) Pub. No.: US 2026/0152152 A1
(43) Pub. Date: Jun. 4, 2026

(54) System and Method For Detecting Seating of Tire Beads During Tire Inflation

(71) Applicant: Hunter Engineering Company, Bridgeton, MO (US)

(72) Inventors: Gregory F. Meyer, St. Louis, MO (US); Joel Clasquin, Highland, IL (US); Mark E. Stirnemann, Arnold, MO (US)

(21) Appl. No.: 19/399,231

(22) Filed: Nov. 24, 2025

Related U.S. Application Data
(60) Provisional application No. 63/727,526, filed on Dec. 3, 2024.

(51) Int. Cl. B60S 5/04; B60C 25/05

(52) U.S. Cl. CPC B60S 5/046; B60C 25/0551; B60C 25/0554; B60C 25/056

(57) ABSTRACT

A vehicle wheel service system, such as a wheel balancer, tire changer, or inflation cage configured with a supply of pressurized air to seat and inflate an uninflated tire mounted onto a rim of a wheel assembly, and to detect the occurrence of tire beads seating onto the wheel rim during the inflation process. The vehicle wheel service system includes a processor configured with software instructions to control a flow of pressurized air into the tire during an inflation process, and to receive input from one or more sensors responsive to the seating of the inner and outer tire beads. The processing system is further configured to utilize the received input to detect the occurrence of the tire bead seating, and to terminate the inflation process either immediately or upon reaching a selected inflation pressure.

### CROSS-REFERENCE TO RELATED APPLICATIONS

The present application is related to, and claims priority from, co-pending U.S. Provisional Patent Application Ser. No. 63/727,526 filed on Dec. 3, 2024 which is herein incorporated by reference.

### STATEMENT REGARDING FEDERALLY SPONSORED RESEARCH

Not Applicable.

### BACKGROUND OF THE DISCLOSURE

The present application is related generally to vehicle wheel service systems such as tire changers, wheel balancers, or tire inflation systems which may be configured to inflate a tire mounted to a wheel rim, and in particular, to systems and methods for the detecting an occurrence of a tire bead seating event while inflating a tire mounted to a wheel rim by an vehicle wheel service system.

During vehicle wheel assembly service procedures such as tire replacement, repair, or rotation carried out using a tire changing machine, a wheel balancing machine, and/or an tire inflation system/cage, tires are mounted onto associated wheel rims and inflated to a desired inflation pressure. During the mounting process, the inner circumferential edges of the uninflated tire, commonly known as beads, are axially fitted over an outer circumferential edge of the wheel rim to surround an axial barrel or drop center portion of the wheel rim. An introduction of pressurized air between the wheel rim and tire carcass to inflate the tire expands the tire sidewalls in axially opposite directions, driving the tire beads axially towards the inner and outer bead seat surface adjacent to the axially inner and outer circumferential edges of the wheel rim. Most wheel rims incorporate at least one raised circumferential region axially inward of at least one bead seat surface, known as a safety hump, which is intended to reduce the risk of an underinflated or deflated tire separating from the wheel rim during use. During inflation, the tire beads will initially resist moving over the safety humps. Once the initial resistance is overcome by the pressure of the introduced air, the tire beads will rapidly push over the safety hump, generating an audible pop or noise as each tire bead engages the corresponding wheel rim bead seat. Technicians manually inflating a tire commonly interpret the audible pop or noise as a sign that the tire has properly seated to the wheel rim and that they may proceed with additional steps of either fully inflating the wheel to a target pressure or carrying out a wheel assembly imbalance correction process.

During the initial inflation of the tire prior to the seating of the beads, the technician monitors the inflation process to ensure that the tire eventually seats properly onto the wheel rim, and that an overinflation condition does not occur by manually controlling the flow of air into or out of the tire to achieve a final inflation pressure. Accordingly, it would be advantageous to provide a method for automating detection of tire bead seating events to eliminate the need for the technician to monitor the entire inflation process, enabling them to perform other tasks as the tire inflates, as well as to automatically verify proper seating of the tire beads to the wheel rim.

### BRIEF SUMMARY OF THE DISCLOSURE

The present disclosure is directed towards a vehicle wheel service system, such as a wheel balancer, tire changer, or inflation system configured with a controlled supply of pressurized air to automatically seat and inflate an uninflated tire mounted onto a rim of a wheel assembly, and to detect occurrences of tire beads seating onto the wheel rim during the inflation process. The vehicle wheel service system includes a processor configured with software instructions to control a flow of pressurized air into the tire during an inflation process, and to receive input from one or more sensors responsive to the seating of the inner and outer tire beads. The processing system is further configured to utilize the received input to detect the occurrence of the tire bead seating, and to respond by terminating the inflation process either immediately or upon reaching a selected inflation pressure within the wheel assembly.

In one embodiment, the one or more sensors responsive to the occurrence of the tire beads seating onto the wheel rim include a microphone configured to capture the audible sound generated when each tire bead passes over a safety hump and seats onto the wheel rim. Output signals generated by the microphone are conveyed to the processor configured with audio processing software instructions to monitor the output signals for characteristic waveforms representative of the bead seating audible sound. When such a characteristic waveform is detected, the processor registers the event occurrence, which in turn can either be communicated to other control modules within the vehicle wheel service system, or which can be used to trigger an operational change or response, such as the termination of an inflation process.

In a further embodiment, the one or more sensors include a plurality of microphones with at least one microphone disposed to capture ambient noise in the environment of the vehicle service system, and wherein the processor is configured with software instructions to utilize signals representative of the captured ambient noise to filter or cancel the ambient background noise from the general sound of the tire inflation, clarifying or enhancing the audible sound generated when the tire beads seat onto the wheel rim.

In another embodiment, the one or more sensors include a plurality of microphones wherein at least two microphones are in a spaced arrangement in proximity to the wheel assembly. Each of the at least two microphones is configured to convey a time-stamped output signal to the processor. The processor in turn is further configured with software instructions to utilize the time-stamped output signals from each microphone to identify a relative spatial location of a detected audible sound generated when a tire bead seats on the wheel rim, enabling separate detection for the inner and outer tire bead seating events. When inner and outer bead seating events are detected, the processor registers each event occurrence, which in turn can either be communicated to other control modules within the vehicle wheel service system, or which can be used to trigger an operational change or response, such as the termination of an inflation process following two bead seating events, or the generation of a warning message if only one tire bead seating event occurs. In yet another embodiment, the one or more sensors responsive to the occurrence of the tire beads seating onto the wheel rim include at least one piezo sensor disposed on a structure of the vehicle wheel service system, and which is responsive to mechanical vibrations generated when the tire beads seat onto the wheel rim. Output signals generated by the at least one piezo sensor are conveyed to the processor, which is configured with signal processing software instructions to monitor the output signals for characteristic vibrational waveforms representative of tire bead seating events. The signal processing software instructions may utilize a pattern matching analysis to identify the characteristic vibrational waveforms, and/or may be configured to utilize artificial intelligence techniques such as a trained neural network or model to recognize vibrations resulting from an occurrence of a tire bead seating event. When one or more bead seating events are detected, the processor registers each event occurrence, which in turn can either be communicated to other control modules within the vehicle wheel service system, or which can be used to trigger an operational change or response, such as the termination of an inflation process following two bead seating events, or the generation of a warning message if only one tire bead seating event occurs.

In yet another embodiment, the one or more sensors responsive to the occurrence of the tire beads seating onto the wheel rim include at least one optical sensor disposed with a field of view encompassing at least a portion of a tire sidewall and/or the wheel rim and tire interface. Images captured by the optical sensor are conveyed to the processor configured with image processing software instructions for evaluating the captured images to detect spatial changes occurring at the tire sidewall and/or at the wheel rim and tire interface which correspond to seating of the tire beads. The image processing software instructions may be configured to perform a pattern matching analysis on the captured images, and may be configured to utilize artificial intelligence techniques such as a trained neural network or model to recognize an occurrence of tire bead seating event. When one or more bead seating events are detected, the processor registers each event occurrence, which in turn can either be communicated to other control modules within the vehicle wheel service system, or which can be used to trigger an operational change or response, such as the termination of an inflation process following two bead seating events, or the generation of a warning message if only one tire bead seating event occurs.

In an alternate embodiment, the one or more sensors responsive to the occurrence of the tire beads seating onto the wheel rim include at least one distance sensor disposed to measure a separation between the sensor and a portion of the tire sidewall. Distance data captured by the sensor is conveyed to the processor configured with software instructions to detect changes in distance resulting from movement of the tire sidewall as the tire beads set to the wheel rim. The processing software instructions may be configured to detect a change in distance exceeding a threshold, or the tire sidewall surface moving to a specific distance from the sensor, and may be configured to utilize artificial intelligence techniques such as a trained neural network or model to recognize an occurrence of tire bead seating event from the acquired distance data. When one or more bead seating events are detected, the processor registers each event occurrence, which in turn can either be communicated to other control modules within the vehicle wheel service system, or which can be used to trigger an operational change or response, such as the termination of an inflation process following two bead seating events, or the generation of a warning message if only one tire bead seating event occurs.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a perspective view of an exemplary prior art tire changer used to mount and demount tires to/from wheel rims;

FIG. 2 is a perspective view of an exemplary prior art wheel balancer used to measure and correct wheel assembly imbalance conditions;

FIG. 3 is a close-up perspective view of an the prior art wheel balancer of FIG. 2, with a wheel assembly secured there to;

FIG. 4 is a cross section view of a wheel assembly consisting of a wheel rim and an uninflated tire prior to bead seating;

FIG. 5 is close view of the rim and tire interface for the wheel assembly shown in FIG. 4;

FIG. 6 is a view similar to FIG. 5, illustrating an introduction of pressurized air to seat the tire beads to the wheel rim; and

FIG. 7 is a view similar to FIG. 5, illustrating an inflated tire having seated beads.

Corresponding reference numerals indicate corresponding parts throughout the several figures of the drawings. It is to be understood that the drawings are for illustrating the concepts set forth in the present disclosure and are not to scale.

Before any embodiments of the disclosure are explained in detail, it is to be understood that the disclosure is not limited in its application to the details of construction and the arrangement of components set forth in the following description or illustrated in the drawings.

### DETAILED DESCRIPTION

The following detailed description illustrates the disclosure by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

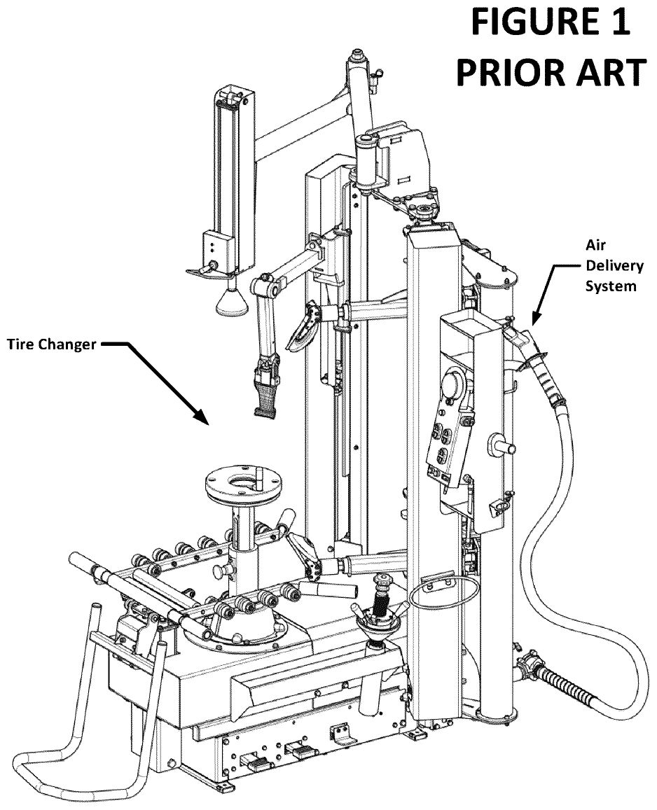

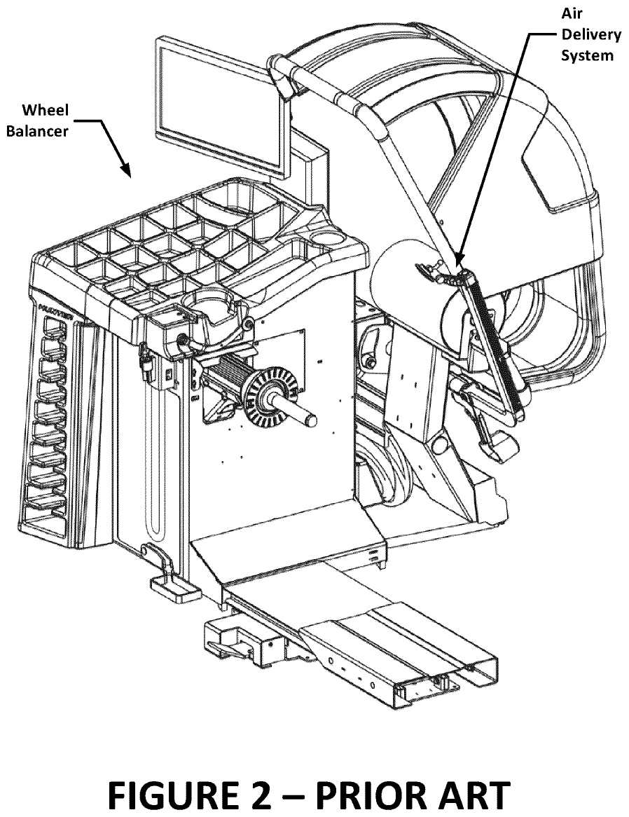

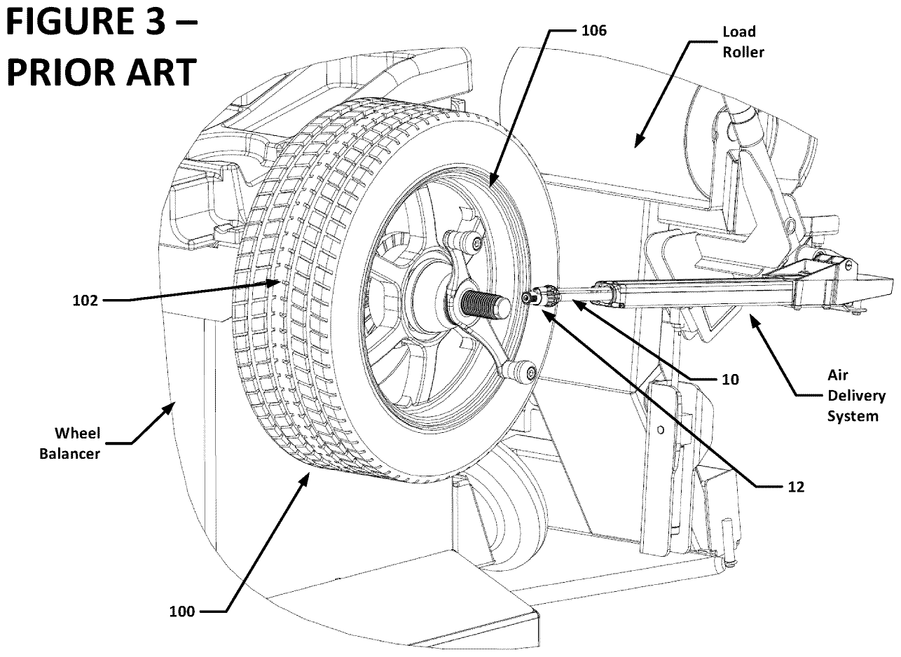

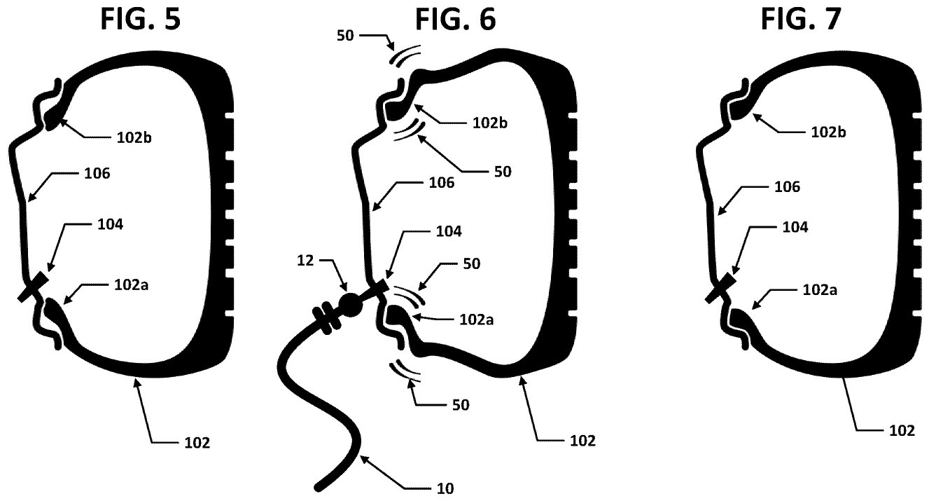

Various vehicle wheel service systems, such as tire changers (FIG. 1), wheel balancers (FIGS. 2-3), and tire inflation cages are commonly configured with components to deliver a flow of pressurized air to a wheel assembly 100 for inflation of a tire 102 mounted there on. These components, such as seen in FIG. 3, may include an air supply line 10 linking a source of pressurized air to an air chuck 12 adapted to connect to an inflation valve 104 on a rim 106 of the wheel assembly 100. A control valve under control of a processing system regulates the flow of pressurized air through the air supply line 10, either in response to an operator command, or to inflation pressure in the tire or air supply line monitored by the processing system via one or more suitable pressure sensors. The processing system is configured with software instructions to inflate the tire 102 to a desired inflation pressure automatically and/or in response to operator commands, such as show in FIGS. 5-7. If the vehicle wheel service system is a tire changer, the processing system may be further configured with software instructions to utilize various tools to facilitate seating the uninflated tire 102 onto the wheel rim 106 prior to starting an inflation process.

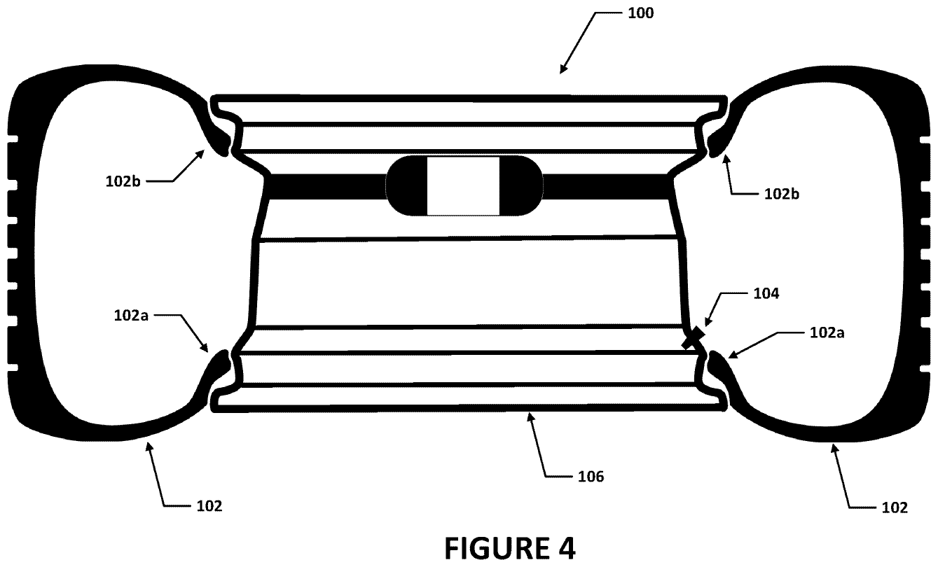

In order to ensure that the uninflated tire 102 (as shown in FIGS. 4 and 5) is properly seated onto the wheel rim 106 (as shown in FIG. 7) and capable of holding pressurized air, the processing system is configured with software instructions to monitor the wheel assembly 100 during an introduction of pressurized air into the uninflated tire 102 in order to detect seating of an inner bead 102a and an outer bead 102b onto the wheel rim 106 as the tire 104 expands (as shown in FIG. 6) in response to the increase in air pressure. The inflation of the tire 102 and seating of the inner and outer beads 102a, 102b may be conducted with the wheel assembly secured in a stationary position, or may occur while the wheel assembly is undergoing rotation about an axis of a spindle onto which it is secured. For example, on a wheel balancer equipped with a load roller such as shown in FIGS. 2-3, the wheel assembly may be rotated during inflation to allow for the load roller to apply a radially directed force to the tire tread surface, facilitating bead seating.

In a first embodiment of the present disclosure, the processing system is configured with software instructions to monitor the wheel assembly 100 during tire bead seating and inflation by receiving data from one or more microphones located in proximity to the wheel assembly 100. Each microphone is configured to receive sound waves 50 generated by the seating of the inner and outer tire beads 102a, 102b onto the wheel rim 106, as illustrated in FIG. 6. Output signals generated by the one or more microphones are conveyed to the processing system, and are evaluated utilizing audio processing software instructions to detect characteristic signals or waveforms which correspond to audible sounds generated by the bead seating events. The characteristic signals or waveforms may be detected by the audio processing software instructions using a pattern matching algorithm which compared known bead seating signals or waveforms with the received signals to detect a bead seating event. Alternatively, the audio processing software instructions may use a threshold detection algorithm to identify signals or waveforms exceeding a threshold of intensity for a specific duration (i.e., a sudden signal spike corresponding to an audible “pop” generated by the bead seating event). In yet another variation, the audio processing software instruction may apply an AI-based model, such as a trained neural network, to detect a bead seating event from the received output signals. Those of ordinary skill in the art will recognize that conventional filtering techniques for audio signals may be applied to the received output signals to enhance or de-emphasize specific frequencies or waveforms as part of the audio processing. When one or more bead seating events are detected, the processor registers each event occurrence, which in turn can either be communicated to other control modules within the vehicle wheel service system, or which can be used to trigger an operational change or response, such as the termination of an inflation process following two bead seating events, or the generation of a warning message if only one tire bead seating event occurs within a selected period of time.

In a variation of the first embodiment, the processing system is further configured to receive data from at least one additional microphone disposed to capture ambient noise in the environment of the vehicle service system. The data received from the at least on additional microphone is utilized by the processing system software instructions to filter or cancel ambient background noise signals from the from signals received from the one or more microphones representing the general sound of the tire inflation, thereby clarifying or enhancing sound waves 50 generated by the seating of the inner and outer tire beads 102a, 102b.

In a further variation of the first embodiment, the processing system is configured to receive time-stamped output data from at least two microphones in a spaced arrangement in proximity to the wheel assembly 100. Using the audio processing software, the processing system utilize the time-stamped output data to identify a relative spatial location for the source of any characteristic signals or waveforms which correspond to the audible sounds generated by the bead seating events, enabling the processing system to separately detect occurrences of the inner tire bead seating event and the outer tire bead seating event.

In a second embodiment of the present disclosure the processing system is configured to monitor the wheel assembly 100 during bead seating and tire inflation by receiving data from one or more piezo sensors disposed on a support structure of the vehicle wheel service system, which are capable of capturing mechanical vibrations generated when the tire expands and the beads 102a, 102b seat onto the wheel rim 106 as illustrated in FIG. 6. The piezo sensors may be dedicated to the detection of bead seating events, or may be further utilized for other purposes, such as measurement of imbalance forces exerted by the wheel assembly 100 during rotation. Output signals generated by the one or more piezo sensors conveyed to the processing system are evaluated utilizing signal processing software instructions to detect characteristic vibrational waveforms generated by the movement of the inner and outer tire beads during bead seating events. The characteristic vibrational waveforms may be detected by the processing system using a pattern matching algorithm which compared known bead seating vibrational waveforms with the received signals to detect an occurrence of a bead seating event. Alternatively, the processing system may use a threshold detection algorithm to identify vibrational waveforms exceeding a threshold of intensity for a specific duration (i.e., a sudden vibration corresponding to the audible “pop” generated by a tire bead seating event). In yet another variation, the processing system may utilize an Al-based model, such as a trained neural network, to detect a bead seating event in the received output signals. Those of ordinary skill in the art will recognize that conventional filtering techniques for signals may be applied to the received output signals by the processing system to enhance or de-emphasize specific frequencies or waveforms as part of the signal processing. When one or more bead seating events are detected, the processing system registers each event occurrence, which in turn can either be communicated to other control modules within the vehicle wheel service system, or which can be used to trigger an operational change or response, such as the termination of an inflation process following two bead seating events, or the generation of a warning message if only one tire bead seating event occurs within a selected period of time.

In a third embodiment of the present disclosure the processing system is configured to monitor the wheel assembly 100 during tire bead seating and tire inflation by receiving data from one or more optical sensors disposed to view at least a portion of a tire sidewall and/or the wheel rim and tire interface. Images of the stationary or rotating wheel assembly are captured by the optical sensor(s) and conveyed to the processing system where they are evaluated utilizing image processing software to detect changes occurring at the tire sidewall and/or at the wheel rim and tire interface which correspond to a seating of the tire beads. For example, the processing system may be configured with the image processing software to perform a pattern matching analysis on the captured images, or may be configured to utilize artificial intelligence techniques such as a trained neural network or model to recognize an occurrence of tire bead seating. In yet another example, the processing system may be configured with the image processing software to detect or identify displacement of the tire sidewall surfaces relative to the wheel rim resulting from a bead seating event. Alternatively, the image processing software may apply an Al-based model, such as a trained neural network, to distinguish an image of a seated tire bead from an image of an unseated tire bead. Those of ordinary skill in the art will recognize that the processing system may utilize the image processing software to apply various filters or masks to emphasize or obscure features, changes, or regions visible within each captured image frame so as to facilitate detection of a tire bead seating event. When one or more bead seating events are detected, the processor registers each event occurrence, which in turn can either be communicated to other control modules within the vehicle wheel service system, or which can be used to trigger an operational change or response, such as the termination of an inflation process following two bead seating events, or the generation of a warning message if only one tire bead seating event occurs within a selected period of time.

In a fourth embodiment of the present disclosure the processing system is configured to monitor the wheel assembly 100 during bead seating and tire inflation by receiving data from one or more distance sensors each disposed to measure a separation between the sensor and a portion of the tire sidewall. Distance data captured by the sensors while the wheel assembly is held stationary or during rotation is conveyed to the processing system and evaluated by a software program to detect axial movement of the tire beads from unseated to seated positions on the wheel rim. The processing system software program may be configured to identify changes in distances which exceeding a threshold as representative of tire bead seating, or may be configured to utilize artificial intelligence techniques such as a trained neural network or model to recognize an occurrence of tire bead seating from the acquired distance data. When one or more bead seating events are detected, the processor registers each event occurrence, which in turn can either be communicated to other control modules within the vehicle wheel service system, or which can be used to trigger an operational change or response, such as the termination of an inflation process following two bead seating events, or the generation of a warning message if only one tire bead seating event occurs within a selected period of time.

The processing system in each embodiment of the present disclosure may be further configured with software instructions to carry out additional actions following detection of the bead seating events for both the inner and outer tire beads 102a, 102b. For example, the processing system may be configured with software instructions to adjust the tire inflation pressure to achieve a target inflation, either by continuing to introduce pressurized air into the tire to reach the target inflation, or by discharging pressurized air from the tire if the tire was over-inflated to seat the tire beads 102a, 102b. Once the target inflation pressure is achieved, the processing system may be configured to either signal the operator or to trigger an automatic disconnect of the air chuck 12 if the wheel service system is configured with an automatic disconnect air chuck. Similarly, the processing system may be configured with software instructions to generate a record of the bead seat occurrences and/or to proceed with wheel services such as bead seat verification or wheel imbalance measurement after the air chuck has been disconnected from the wheel assembly.

Methods for seating the tire beads 102a, 102b of a tire 102 on a wheel assembly 100 may be varied in response to operator preferences or the characteristics of the tire, rim, or wheel assembly configuration. Accordingly, the processing system of the present disclosure may be configured with software instructions to alter one or more aspects of a tire bead seating procedure in response to operator instructions. Operator instructions may be received via an operator interaction with a graphical user interface, or via direct operator input such as through dials, switches, or buttons. Exemplary aspects of a tire bead seating procedure which may be altered include an overinflation pressure multiplier, a maximum overinflation pressure, a dwell time, and use of a load roller on vehicle wheel service systems so equipped.

An overinflation pressure multiplier establishes a maximum inflation pressure which may be introduced into the tire to induce bead seating based on an intended final inflation pressure for the tire. For example, a graphical user interface under control of the processing system may be configured to present the operator with an overinflation setting adjustable between 1.0 and 1.5. If the multiplier is set to 1.5 and the final target pressure is set to 32 PSI, then the permitted overinflation pressure would be 48 PSI (32×1.5).

A maximum overinflation pressure value is a specific pressure value defining a maximum inflation pressure which may be introduced into the tire by the processing system to induce bead seating regardless of any set overinflation pressure multiplier. The use of a maximum inflation pressure value serves as a safety limit, ensuring that a tire is not inflated beyond a safe level during seating of the tire beads.

Setting a dwell time directs the processing system to establish a period of time for an inflated tire to remain at a maximum inflation pressure during a tire bead seating operation before automatic deflation to a lower target inflation pressure occurs. Doing so allows for the tire beads to seat to the rim gradually over an extended period of time.

For vehicle wheel service systems equipped with a load roller configured to exert a radial force against a tire on a wheel rim secured to a rotating spindle, directing the processing system to utilize the load roller as part of a tire bead seating procedure enables the processing system to monitor bead seating progress or to verify proper tire bead seating by monitoring directly, or indirectly, the engagement force between the tire and load roller. When the load roller is brought into contact with the tire surface, and the tire is rotationally driven or “spun”, a representation of the resulting engagement force on the load roller is measured by one or more sensors and conveyed to the processing system. For example, a representation of the resulting engagement force may be calculated by utilizing a measure of the force used to rotate load roller into engagement with the tire together with a measure of the angular displacement of the load roller. If the engagement forces are measured during the tire bead seating operation, each bead seating event will result in a rapid change in the engagement force. Monitoring the engagement force to detect such changes provides an indication of a tire bead seating event to the processing system. Verification of proper bead seating may be done by noting that a wheel assembly having improperly seated tire beads will exhibit different engagement forces from those observed for a wheel assembly having a properly seated and inflated tire. The processing system may be configured with software instructions to generate suitable messages to an operator upon detection of engagement forces indicative of improper bead seating (or conversely, indicative of proper bead seating) when engaging a load roller with the tire following a bead seating operation. In some instances, application of a radial force to the tire by the load roller during wheel assembly rotation following an incomplete bead seat operation may facilitate proper seating of the tire beads. Accordingly, the processing system may be configured to monitor engagement forces for a period of time during tire rotation following a bead seating operation, or for a set number of tire rotations in an attempt to correct or improve a detected incomplete seating of a tire bead.

A load roller in engagement with the tread surface of a rotating tire on a wheel rim secured to a rotating spindle may be utilized by the processing system to monitor a bead seating progress or to verify proper tire bead seating tracking the radial runout of the wheel assembly. When the load roller is brought into contact with the tire surface, and the tire is rotationally driven or “spun”, a one or more sensors coupled to the load roller support structure measure a relative displacement of the load roller. Radial runout present in the wheel assembly is observed as a cyclical variation in the measured relative displacement during rotation of the wheel assembly while engaged with the load roller. If the radial runout is monitored during the tire bead seating operation, each bead seating event will result in a change in observed radial runout. Monitoring the radial runout to detect such changes provides an indication of a tire bead seating event to the processing system. The processing system may be configured with software instructions to generate suitable messages to an operator upon detection of radial runout changes indicative of improper bead seating (or conversely, indicative of proper bead seating) when engaging a load roller with the tire during a bead seating operation.

The present disclosure can be embodied in-part in the form of computer-implemented processes and apparatuses for practicing those processes. The present disclosure can also be embodied in-part in the form of computer program code containing instructions embodied in tangible media, or another computer readable non-transitory storage medium, wherein, when the computer program code is loaded into, and executed by, an electronic device such as a computer, micro-processor or logic circuit, the device becomes an apparatus for practicing the present disclosure.

The present disclosure can also be embodied in-part in the form of computer program code, for example, whether stored in a non-transitory storage medium, loaded into and/or executed by a computer, or transmitted over some transmission medium, wherein, when the computer program code is loaded into and executed by a computer, the computer becomes an apparatus for practicing the present disclosure. When implemented in a general-purpose microprocessor, the computer program code segments configure the microprocessor to create specific logic circuits.

As various changes could be made in the above constructions without departing from the scope of the disclosure, it is intended that all matter contained in the above description or shown in the accompanying drawings shall be interpreted as illustrative and not in a limiting sense.

1. A vehicle wheel service system having a processing system configured with software instruction to perform at least one wheel service procedure on a wheel assembly consisting of a wheel rim and an associated tire, and a means to deliver a flow of pressurized air to the wheel assembly for inflation and deflating the tire, comprising:
at least one sensor configured to communicate a signal to said processing system which is responsive to, or indicative of, an occurrence of a tire bead seating event during inflation of said tire; and
wherein said processing system is further configured with software instructions to monitor said communicated signal to detect an occurrence of a tire bead seating event as a step in a tire inflation procedure.

2. The vehicle wheel service system of claim 1 configured as one of a wheel balancer, a tire changer, or an inflation cage.

3. The vehicle wheel service system of claim 1 wherein said means to deliver said flow of pressurized air to said wheel assembly comprises an air supply line coupling a source of pressurized air to an air chuck, said air chuck adapted to connect to an inflation valve on said wheel assembly;
a control valve under control of said processing system, said control valve configured to regulate said flow of pressurized air through said air supply line; and
wherein said processing system is further configured to monitor said flow of pressurized air and/or an inflation pressure within a tire of said wheel assembly, to operate said control valve to achieve a target inflation pressure within said tire.

4. The vehicle wheel service system of claim 1 wherein said at least one sensor is a microphone;
wherein said communicated signal is representative of sounds generated during said tire inflation procedure;
wherein said processing system is configured with software instructions to monitor said communicated signal to detect occurrences of characteristic sounds or acoustic waveforms generated during said tire bead seating event; and
wherein said processing system is configured with software instructions to respond to a detected occurrence by subsequently altering a flow of pressurized air inflating said tire and/or providing an indication of tire bead seating to said operator.

5. The vehicle service system of claim 4 wherein said at least one sensor includes a second microphone;
wherein said communicated signal from said second microphone is representative of ambient noise in proximity to said vehicle wheel service system; and
wherein said processing system is further configured with software instructions to utilize said communicated signal from said second microphone to process said communicated signal representative of sounds generated during said automatic tire inflation procedure by isolating said occurrences of characteristic sounds or acoustic waveforms generated during said tire bead seating event.

6. The vehicle service system of claim 4 wherein said at least one sensor includes a second microphone at a location which is spatially separated from a location of said at least one microphone;
wherein said communicated signal from said second microphone is representative of sounds generated during said tire inflation procedure received at said associated spatial location; and
wherein said processing system is further configured with software instructions to utilize said communicated signal from said second microphone to determine a spatial location for a source of said characteristic sounds or acoustic waveforms generated during said tire bead seating event to distinguish between seating of an inner tire bead and seating of an outer tire bead.

7. The vehicle wheel service system of claim 1 wherein said at least one sensor is a piezo sensor mounted to a structure supporting said wheel assembly;
wherein said communicated signal is representative of vibrations generated during said tire inflation procedure;
wherein said processing system is configured with software instructions to monitor said communicated signal to detect occurrences of characteristic vibrational waveforms generated during said tire bead seating event; and
wherein said processing system is configured with software instructions to respond to a detected occurrence by subsequently altering a flow of pressurized air inflating said tire and/or providing an indication of tire bead seating to said operator.

8. The vehicle service system of claim 7 wherein said processing system is configured with software instructions to detect occurrences of said characteristic vibrational waveforms utilizing at least one pattern matching algorithm to compare a known bead seating vibrational waveform with said communicated signals to detect said tire bead seating event.

9. The vehicle service system of claim 7 wherein said processing system is configured with software instructions to detect occurrences of said characteristic vibrational waveforms utilizing a threshold detection algorithm to identify vibrational waveforms exceeding a threshold of intensity for a specific duration.

10. The vehicle service system of claim 7 wherein said processing system is configured with software instructions to detect occurrences of said characteristic vibrational waveforms utilizing an AI-based model or trained neural network.

11. The vehicle wheel service system of claim 1 wherein said at least one sensor is an optical sensor having a field of view encompassing at least a sidewall portion of said associated tire;
wherein said communicated signal includes a plurality of images of said associated tire sidewall portion;
wherein said processing system is configured with software instructions to evaluate said plurality of images to detect changes to said observed tire sidewall and/or to a position of said associated tire sidewall relative to said wheel rim indicative of a seated tire bead; and
wherein said processing system is configured with software instructions to respond to a detected changes by subsequently altering a flow of pressurized air inflating said tire.

12. The vehicle service system of claim 11 wherein said processing system is configured with software instructions to detect said changes to said tire sidewall and/or to said position of said associated tire sidewall relative to said wheel rim utilizing an AI-based model or trained neural network.

13. The vehicle wheel service system of claim 1 wherein said at least one sensor is a distance sensor disposed to measure a distance to a sidewall portion of said associated tire;
wherein said communicated signal includes a plurality of distance measurements to said associated tire portion;
wherein said processing system is configured with software instructions to evaluate said plurality of distance measurements to detect changes to said tire sidewall and/or to a position of said associated tire sidewall relative to said wheel rim indicative of a seated tire bead; and
wherein said processing system is configured with software instructions to respond to a detected changes by subsequently altering a flow of pressurized air inflating said tire and/or providing an indication of tire bead seating to said operator.

14. The vehicle wheel service system of claim 1 further including a load roller assembly operatively controlled by said processing system to exert a radial load on said tire during rotation of said wheel assembly about a rotational axis of a supporting spindle to which the wheel assembly is temporarily secured;
wherein said at least one sensor is configured to measure a representation of a force exerted by load roller on said tire during driven rotation of said wheel assembly about said rotational axis;
wherein said communicated signal is representative of said measured force;
wherein said processing system is configured with software instructions to evaluate said communicated signal to distinguish between a wheel assembly having seated tire beads and a wheel assembly having unseated tire beads; and
wherein said processing system is configured with software instructions to respond to said evaluated signal by generating an output to an operator indicative of a bead seat state for said wheel assembly.

15. The vehicle wheel service system of claim 1 further including a load roller assembly operatively controlled by said processing system to exert a radial load on said tire during rotation of said wheel assembly about a rotational axis of a supporting spindle to which the wheel assembly is temporarily secured;
wherein said at least one sensor is configured to measure at least one parameter associated with a force exerted by said load roller on said tire during driven rotation of said wheel assembly about said rotational axis during tire inflation, wherein said at least one parameter corresponds to an applied force, an applied pressure, or an angular rotation of a load roller support structure;
wherein said communicated signal is representative of said measured force;
wherein said processing system is configured with software instructions to use said communicated signal to detect a change in said exerted force during a tire inflation process which is representative of a tire bead seating event; and
wherein said processing system is configured with software instructions to respond to a detected change by subsequently altering a flow of pressurized air inflating said tire.

16. A method for operating a wheel service system having a processing system configured with a set of software instructions for automatically inflating an uninflated tire fitted to a wheel rim of a wheel assembly, comprising;
coupling an inflation valve of said wheel assembly to a controlled source of pressurized air;
inflating said tire by controlling a flow of pressurized air into a volume of space enclosed between said tire and said wheel rim with said processing system;
monitoring said tire during said tire inflation to detect at least one occurrence of bead seating for a tire bead by evaluating at said processing system, one or more signals responsive to a bead seat occurrence generated by one or more sensors;
following detection of said bead seating occurrence for said tire bead by said processing system, subsequently altering said flow of pressurized air under control of said processing system to achieve a target inflation pressure within said tire.

17. The method of claim 16 wherein monitoring said tire during said inflation includes detecting an occurrence of bead seating for an inner tire bead and an occurrence of bead seating for an outer tire bead.

18. The method of claim 17 wherein at least one of said signals is an audio signal output from a microphone of sounds generated during said tire inflation; and
wherein said occurrence of bead seating for each of said inner and outer tire beads is detected by said processing system from identification of an associated characteristic audio signal.

19. The method of claim 17 wherein at least one of said signals is an output from a transducer representative of vibrations generated during said tire inflation; and
wherein said occurrence of bead seating for each of said inner and outer tire beads is detected by said processing system from identification of an associated characteristic vibration signal.

20. The method of claim 17 wherein at least one said signal represents a plurality of images of at least a portion of said tire generated by an imaging sensor during said tire inflation; and
wherein said occurrence of bead seating for each of said inner and outer tire beads is detected by said processing system from visual changes to said tire portion captured in said plurality of images.

21. The method of claim 17 wherein said at least one of said signals is an output from a distance sensor representative of a distance to a portion of said tire during said tire inflation; and
wherein said occurrence of bead seating for each of said inner tire bead and/or said outer tire bead is detected by said processing system from an identification of a change in said distance.

22. The method of claim 16 wherein said step of monitoring said tire includes generating an input to said processing system, said input consisting of one of
an audio signal representative of sounds generated during said tire inflation;
a signal representative of vibrations generated during said tire inflation;
a plurality of images of at least a portion of said tire during said tire inflation; or
a signal representative of a distance to a portion of said tire during said tire inflation; and
wherein said occurrence of bead seating for said tire bead is detected by said processing system from said input.
